(19) United States
(12) Patent Application Publication
(10) Pub. No.: US 2005/0250488 A1
(43) Pub. Date: Nov. 10, 2005

(54) Wireless interface that supports multiple remote station sets and devices

(75) Inventor: Joseph A. Carbonaro, Wheaton, IL (US)

Correspondence Address: DUFT BORNSEN & FISHMAN, LLP, 1526 SPRUCE STREET, SUITE 320, BOULDER, CO, 80302, US

(73) Assignee: Lucent Technologies Inc.

(21) Appl. No.: 10/840,011

(22) Filed: May 6, 2004

(51) Int. Cl. H04Q 7/20

(52) U.S. Cl. 455/426.1; 455/552.1

(57) ABSTRACT

A wireless communication system for serving a small structure, business or household. The need for internal standard building interior telephone cable is avoided by the provision of a plurality of wireless interfaces each of which is associated with a different phone or station device. A single cell phone and its associated wireless interface functions an interface to receive incoming calls from a wireless network service provider and to extend each incoming call via the wireless interfaces to the household phones. Outgoing calls are extended from a calling station via the wireless interfaces to the cell phone which extends the call to via the wireless network to the called station. The cell phone monitors each call connection and ends the call upon the detection of an on-hook signal from either the calling or called station.

### FIELD OF THE INVENTION

This invention relates to a wireless communication system that enables conventional land line station devices, such as telephones, to make and receive external calls via cellular network facilities. More particularly, this invention relates to a wireless communication system having a cell phone that serves calls between the wireless land line station devices and external stations served by cellular networks.

### Problem

Cell phone usage is increasing due to advances in cell phone network technology as well as advances in cell phone capabilities. This increased cell phone usage includes mobile applications such as automobiles, airplanes, cruise ships, hikers, and other applications which serve the communication needs of mobile users. This increased cell phone usage also includes applications in which users such as students and tenants occupying rental facilities forego the use of conventional land lines and use cell phones as their sole communication resource. This increased cell phone usage is also due in part to the fact that many cell phone service providers offer attractive rates for customers who use cell phones as their sole communication resource, both for their mobile communication needs as well as for use in homes and the like.

A cell phone by itself is not ideal for use in a residential environment since most homes are already equipped with a one or more phones connected to a single phone line. Extension phones enable a user to make or answer calls using conveniently placed phones in the bedroom, living room, family room, study, etc. Cell phones are not currently connected on an extension basis to a single line. The exclusive use of cell phones in a home would either require the user to carry a single cell phone throughout the house for the convenient answering of calls or would require the use of a plurality of cell phones throughout the house with each cell phone having its own telephone number. The use of multiple cell phones would not be economical since each cell phone would be billed as a separate entity.

U.S. Pat. Nos. 5,812,637 and 6,466,799 disclose systems in which a single cell phone is used as a wireless/land line interface connected via internal household telephone wiring to the land line phones of the house with the cell phone serving as the sole interface to the outside world for calls received and placed by the phones within the house. The cell phone base is connected via the standard building interior telephone cabling to the land line phones.

The system of these U.S. patents enables all incoming calls received by the cell phone to be answered by any household telephone. However, the system of these patents is limited since it requires each telephone to be connected to the standard telephone house wiring. Such arrangements are not suitable in new housing where telephone wiring is not yet installed or in existing homes where additional telephones are desired in locations not yet equipped with telephone wiring. In such instances, the expense of providing new or modified household telephone wiring may be a deterrent to the use of cell phones as the exclusive provider of communication service.

### Solution

The above and other problems are solved by the present invention in accordance with which a wireless communication system has a wireless interface apparatus to enable a single cell phone to serve as an interface on calls between a wireless network and land line phones of a structure, house or apartment. Incoming calls from a wireless network are received by the cell phone and extended to telephones or other household station devices. The cell phone also functions to extend calls originating from any standard telephone or other station device to the wireless network. The system of the present invention is advantageous in that it does not require the use of standard inside wiring. Instead, wireless interfaces are coupled to the cell phone and to each household telephone or station device. The cell phone and the household telephones communicate via the wireless interfaces independent of any household wiring. The use of the wireless interfaces rather than standard house telephone wiring is advantageous in that it enables all incoming and outgoing calls to be served by the single cell phone and the household land line phones while avoiding the cost of new or reconfigured wiring in the home to accommodate new or rearranged telephone locations. The system of the present invention enables new homes to be served by cellular facilities without incurring the cost of equipping the new home with the standard building telephone wiring. The equipment embodying the present invention is further advantageous since it enables cellular service to be provided throughout the house while accommodating changes in the locations of the telephones without associated changes in the interior wiring.

The telephones within the house may be of any type including corded or cordless. Each telephone is coupled to an associated wireless interface which communicates with a wireless interface coupled to the cell phone. The cell phone receives the incoming call, extends it to its associated wireless interface which extends the call to telephones or station devices within the house via the wireless interfaces coupled to each phone. The telephones ring upon the reception of the call; the incoming call may be answered by any telephone in the house. The off-hook signal generated by the answering telephone terminates the ringing of the phones.

An outgoing call may be placed from any phone in the conventional manner by dialing the number of the called party. The dialed number is extended from the wireless interface coupled to the calling phone to the wireless interface associated with the cellular phone. The dialed digits are then extended to the cell phone and extended further by the cell phone to the wireless network for completion to the called party. The call is monitored for its duration and ended by the cell phone upon the detection of an on-hook signal at either the calling station in the house or by the called station to which the call was directed.

The wireless interfaces provided in accordance with the present invention may be separate devices coupled to the standard household phones as well as the cell phone. Alternatively, the wireless interfaces may be integrated into and comprise a part of the cell phone or the standard house phones. The present invention is further advantageous in that the station devices may include not only the standard household phones but may additionally include other communication facilities such as computers, PDAs, fax machines, printers, household appliances such as refrigerators, fire, security and other alarm detection devices as well as communication paths extending to other networks and/or network appliances.

### DESCRIPTION OF THE DRAWINGS

The above and other advantages, features and aspects of the invention may be better understood from a reading of the following detailed description thereof, taken in conjunction with the drawings in which:

FIG. 1 discloses a first possible preferred exemplary embodiment of the invention;

FIG. 2 discloses further details of the cell phone and its cell phone base;

FIG. 3 discloses a second possible preferred exemplary embodiment of the invention;

FIG. 4 discloses the messages transmitted between the cell phone and the house phones doing the serving of incoming and outgoing calls;

FIGS. 5 and 6 are flowcharts disclosing the operation of systems embodying the present invention.

### DETAILED DESCRIPTION

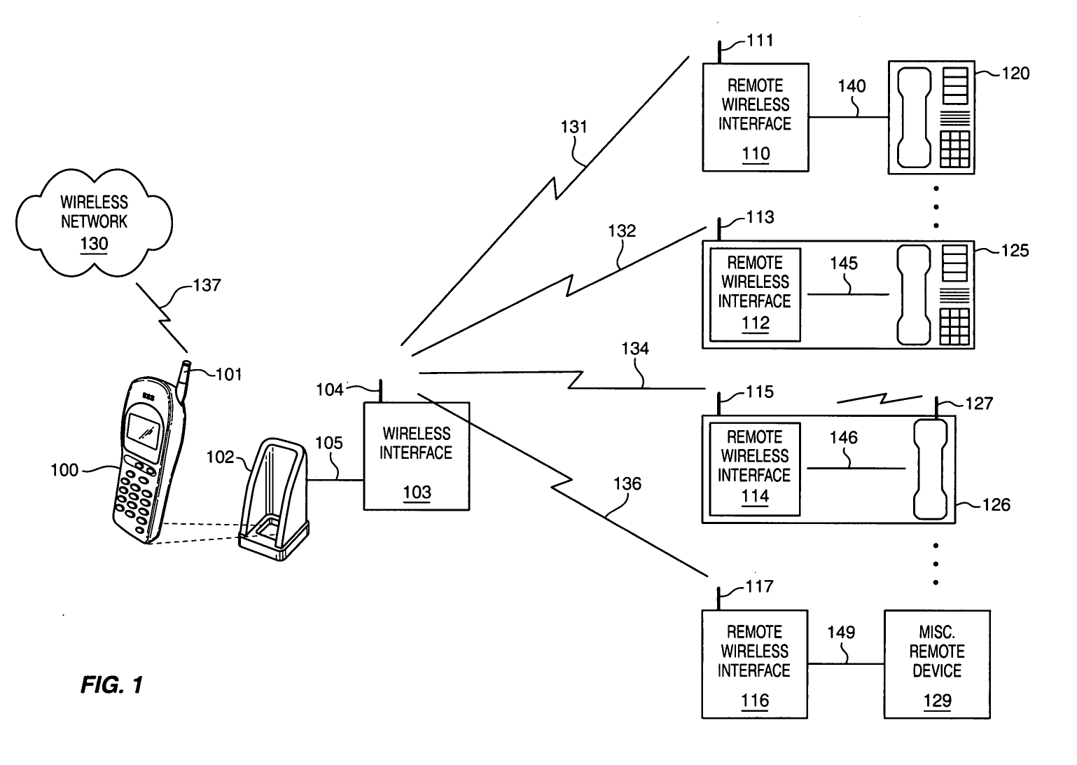

Description of FIG. 1

FIG. 1 discloses a first possible preferred exemplary embodiment of the invention. Shown on FIG. 1 are cell phone 100, antenna 101, cell phone base 102 and a plurality of remote station devices 120-129. The remote station devices include conventional dial phones 120-125, cordless phone 126 and a plurality of miscellaneous remote data devices 129 that use the communication services provided by the system of the present invention including wireless network 130. Miscellaneous remote data devices 129 may include computers, PDAs, fax machines, printers, household appliances, fire, security and alarm detection devices, and communication paths extending to other networks and/or other network appliances.

The system of FIG. 1 does not require standard building interior wiring to interconnect cell phone 100 and remote station devices 120-129. Instead, the system of FIG. 1 includes a plurality of wireless interfaces 103, 110, 112, 114, and 116 which enable cell phone 100 to communicate with remote station devices 120-129. Wireless interface 103 is adapted to be coupled to cell phone base 102. Wireless interfaces 110, 112, 114, and 116 are coupled, respectively, to remote station devices 120-129. The wireless interfaces each include an antenna 104, 111, 113, 115, and 117 which enable the wireless interfaces to communicate during the serving of calls involving cell phone 100 and remote station devices 120-129. Those skilled in the art will readily appreciate that the wireless interfaces may, if desired, be embodied in cell phone base 102 and remote station devices 120-129. Wireless interfaces 103, 110, and 116 are shown as stand alone separate devices; wireless interfaces 112 and 114 are shown embodied in their associated telephones 125 and 126. Those skilled in the art will appreciate it as merely a designer's choice whether or not to provide a wireless interfaces as separate device or whether to incorporate them in base 102 and the station devices with which they are associated.

Cell phone 100 communicates with wireless network 130 to receive calls from network 130 and extend them via the wireless interfaces to remote station devices 120-129. The system of FIG. 1 is also effective to extend any call initiated by remote station devices 120-129 via the wireless interfaces to cell phone 100 which, in turn, extends the outgoing call via wireless network 130 to the called station. Cell phone 100 must be connected to base 102 to function as a wireless interface between remote stations sets 120-129 and the stations served by wireless network 130.

An incoming call from wireless network 130 is received by cell phone 100 which extends it to its wireless interface 103. Wireless interface 103 generates a ring control signal which is transmitted to wireless interfaces 110-116 to apply ringing current to their respective remote station devices 120-129. Let it be assumed that a customer at telephone 120 answers the call by lifting his receiver to generate an off-hook signal. This off-hook signal is transmitted to wireless interface 110 which transmits a call answered signal to wireless interface 103. In response to the reception of the call answered signal, wireless interface 103 ends the generation of the ringing control signal transmitted to wireless interfaces 110-116. This ends the application of ringing of remote station devices 120-129. A voice (or data) communication path is now established between a calling customer served by wireless network 130, cell phone 100, wireless interfaces 103 and 110, and remote station device 120.

Cell phone 100 monitors the call for its duration. The call is terminated by either the calling subscriber served by wireless network 130 going on-hook or by the subscriber at phone 120 going on-hook. In either event, cell phone 100 and its wireless interface 103 detect the on-hook condition and, in the customary manner, end the call. An on-hook signal generated at phone 120 is extended via wireless interface 110 and 103 to apply a call “end” signal to cell phone 100.

The following describes the operation of the system of FIG. 1 when a calling station such as 120 places a call to a subscriber served by wireless network 130. The call begins when the subscriber at station 120 goes off-hook, receives a dial tone from wireless interface 110 and dials the number of the called station. The called digits are extended from wireless interface 110 to wireless interface 103 coupled to cell phone base 102. The off-hook signal generated by station 120 is also transmitted via wireless interfaces 110 and 103 to activate cell phone 100 in preparation for the receipt of the dialed digits. Upon receiving the dialed digits, cell phone 100 transmits the dialed digits to wireless network 130 which functions to extend the call to the called party.

The call is monitored for its duration by cell phone 100. The call is ended when either party to the call goes on-hook. An on-hook signal is received by cell phone 100 which ends the call connection. An on-hook signal generated at station 120 at the end of the call is transmitted via wireless interfaces 110 and 103 and applied to cell phone 100 as a “call end” signal. The call “end” signal returns cell phone 100 to its inactive state in which it awaits the initiation of the next call.

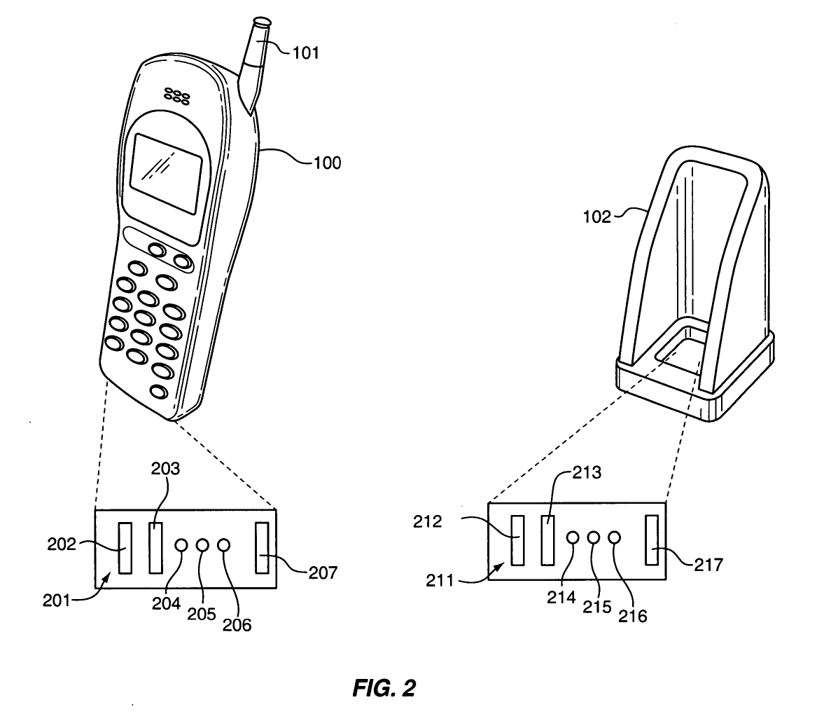

Description of FIG. 2

FIG. 2 discloses further details of cell phone 100 and its base 102. The system of FIG. 1 is operable only when cell phone 100 is positioned in base 102 so that it may electrically communicate with the circuitry of base 102 by means of the terminals shown beneath the cell phone and base 102.

The bottom terminal strip 201 of cell phone 100 contains terminals 202-207. Terminal strip 211 of base 102 contains matching terminals 212-217 which electrically engage cell phone terminals 202-207 when cell phone 100 is positioned in base 102. The connections provided by these terminals enable cell phone 100 to communicate with circuitry in base 102 to function as described on incoming and outgoing calls.

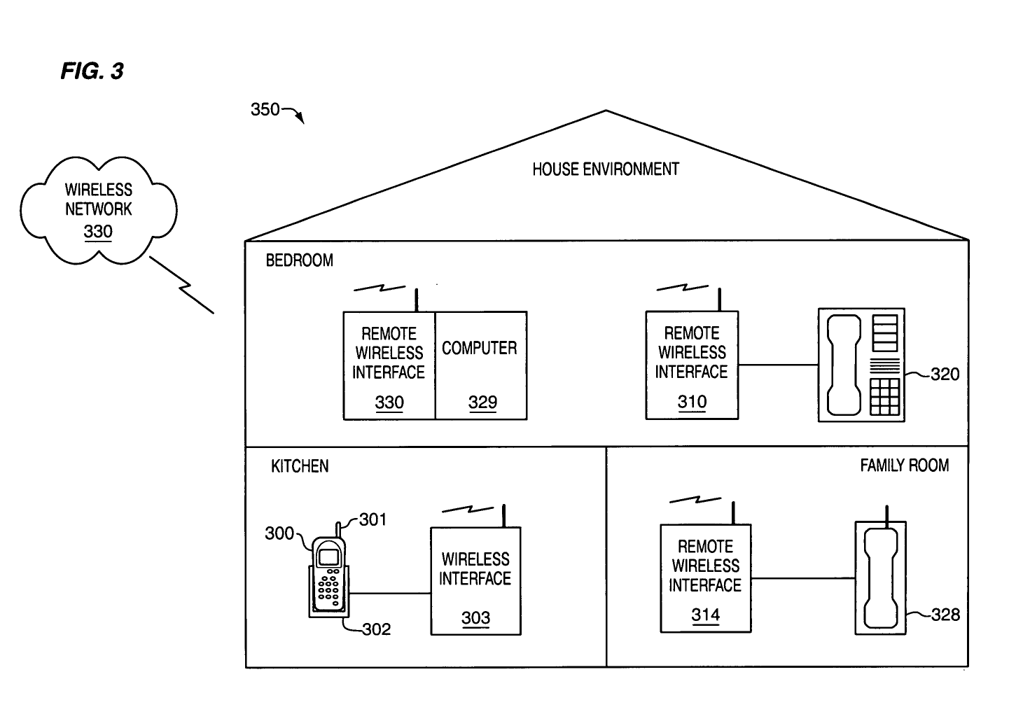

Description of FIG. 3

FIG. 3 discloses a second possible preferred exemplary embodiment of the invention. FIG. 3 discloses a house 350 having a cell phone 300 and its associated wireless interface 303 in the kitchen, a conventional phone 320 and its associated wireless interface 310 in a bedroom, and cordless phone 328 together with its associated wireless interface 314 in the family room. The system of FIG. 3 serves incoming and outgoing calls in the same manner as described for FIG. 1. Cell phone 300 communicates with wireless network 330 shown in the same manner as cell phone 100 of FIG. 1 communicates with wireless network 130. The wireless interfaces 310, 303, and 314 enable the cell phone 300 to communicate with phone 320 and cordless phone 328. The system of FIG. 3 also includes computer 329 having an embedded wireless interface 330 to enable computer 329 to communicate via cell phone 300 and wireless network 330 with an internet service provider. Cell phone 300 includes a base 302 adapted to be connected to an AC power source. Cordless phone 328 includes a base and a charger adapted to be connected to AC power.

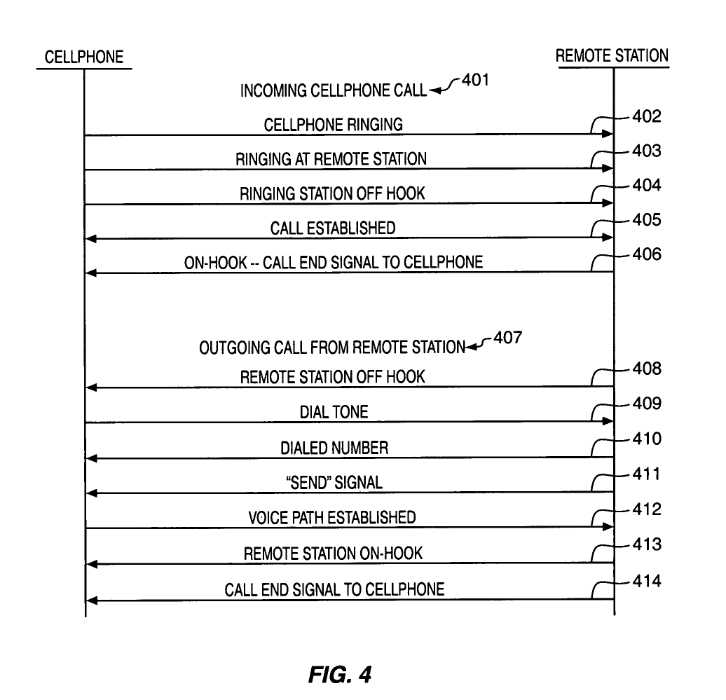

Description of FIG. 4

FIG. 4 lists the messages and information exchanged between cell phone 100 and remote stations 120-129 during the serving of incoming and outgoing calls. The top portion of FIG. 4 illustrates the messages exchanged during the serving of an incoming call 401 to cell phone 100 from a station served by wireless network 130. The reception of the incoming call causes cell phone 100 to ring as shown for message 402. For message 403, cell phone 100 transmits signals via wireless interface 103 and the remote wireless interfaces 110-116 to initiate ringing at remote stations 120-129. All remote stations ring since they are connected functionally in parallel to the same extent as if they were connected to a single household line having a plurality of extension phones. The incoming call is answered by one of the remote stations causing it to go off-hook as shown for message 404. The off-hook state of the answering station establishes a path from the calling station served by wireless network 130 to the answering station of FIG. 1. The establishment of this path enables the two stations to communicate on a voice connection or to communicate by exchanging data if the remote station that went off-hook is one of the miscellaneous remote devices 129 such as a modem of a computer. This is shown for message 405. The call is monitored for its duration by the cell phone until one of the stations on the call goes on-hook. At that time, a “call end” signal is received by the cell phone indicating that the call has ended. The cell phone then ends the connection between the calling and called stations. This is shown for message 406.

Next are described are the messages transmitted between cell phone 100 and a remote station 120-129 in response to the initiation of an outgoing call 407 by a remote station 120-129. The call is initiated when a remote station 120-129 goes off-hook as shown for message 408. The calling station receives a dial tone from its associated wireless interface as shown for message 409. The calling station dials the number of the called station as shown for message 410. The called number is received by the cell phone (message 410) followed by “send” signal (message 411). The cell phone receives the dialed number and the “send” signal and transmits the called number to wireless network 130 which takes the further steps required to complete the call. The call completion is detected by cell phone 100 which then establishes the path to the calling station (message 412). In message 413, the call is ended by one of the parties going on-hook. The cell phone receives a call “end” signal and takes down the connection in response to the reception of an on-hook signal from either the calling or called station (message 414).

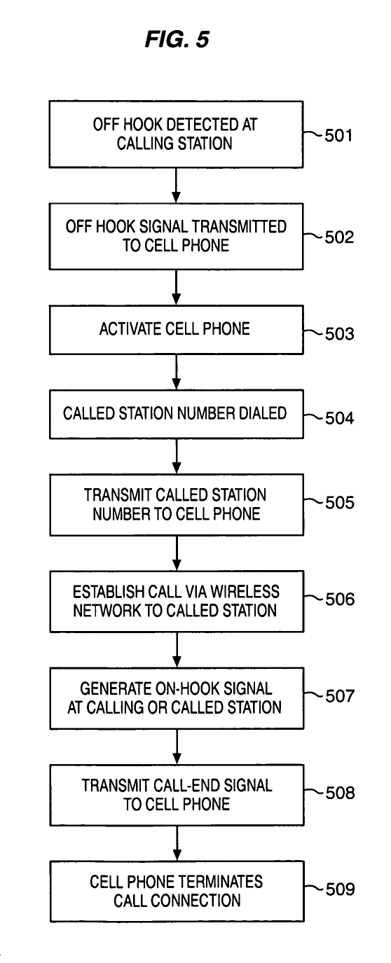

Description of FIG. 5

FIG. 5 illustrates the method by which the systems embodying the invention serves outgoing calls. In step 501, an off-hook signal is detected at the calling station. In step 502, the off-hook signal is transmitted via the wireless interfaces to cell phone 100. Step 503 activates the cell phone. In step 504, the calling station dials the number of the called station. In step 505, the called station number is transmitted via the wireless interfaces to cell phone 100. In step 506, cell phone 100 transmits the called number to wireless network 130 which completes the call to the called station. Cell phone 100 monitors the call for its duration and detects the generation of an on-hook signal in step 507. Step 508 transmits a “call end” signal to cell phone 100 which in step 509 terminates the connection between the calling and called stations.

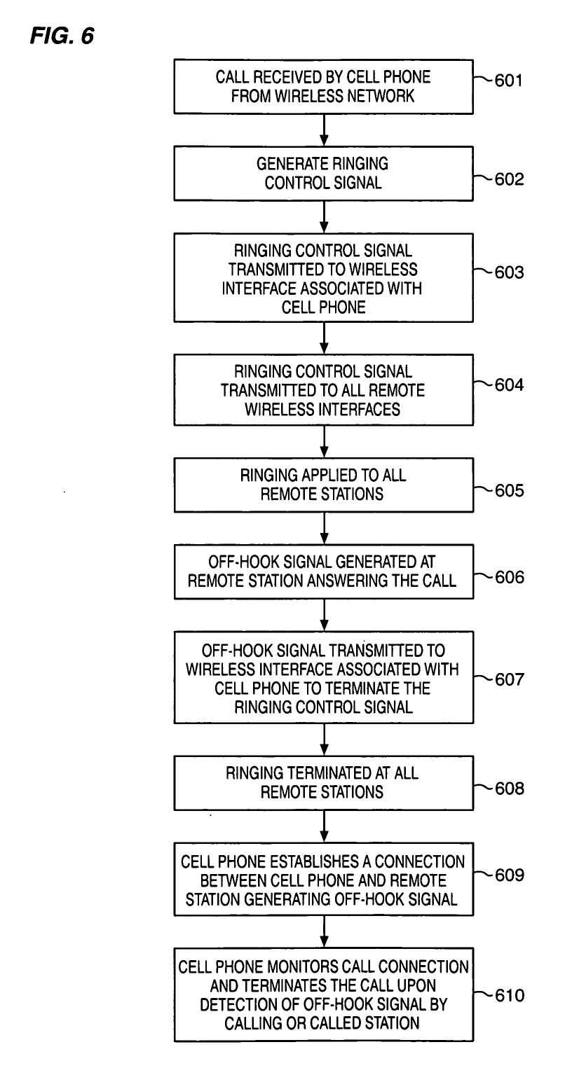

Description of FIG. 6

FIG. 6 describes the steps by which the systems embodying the present invention serve an incoming call received from wireless network 130. An incoming call is received by cell phone 100 in step 601. In step 602, cell phone 100 generates a ringing control signal. Step 603 transmits the ringing control signal from cell phone 100 to wireless interface 103 associated with cell phone 100. Step 604 transmits the ringing control signal from wireless interface 103 to remote wireless interfaces 111-116. Step 605 causes remote wireless interfaces 111-116 to apply ringing current to their associated remote stations 120-129. In step 606, the responding one of the remote stations that answers the call generates an off-hook signal indicating that the call has been answered. Step 607 transmits the off-hook signal to wireless interface 103 associated with the cell phone to terminate the generation of the ringing control signal. Step 608 responds to the termination of the generation of the ringing control signal to end ringing at the remote stations. Step 609 establishes a voice or data path connection between the cell phone and the remote station generating the off-hook signal. In step 610, the cell phone monitors the call connection for its duration and ends the call upon the detection of an on-hook signal by either the calling or called station.

The above description discloses possible exemplary embodiments of the invention. It is expected that those skilled in the art can and will design alternative embodiments that infringe on this invention as set forth in the claims below either literally or through the Doctrine of Equivalents. The term call used herein shall be understood to include communications of all types including voice and data. The terms phone and telephone used herein shall be understood to include stations sets and terminal devices connectable to a communication path or channel to enable the transmission of all types of information, data and signals there over. The terms home, house, household, and business used herein shall be understood to include structures of any type or size suitable for accommodating a communication system embodying the present invention. The term cell phone used herein shall be understood to include wireless telephones and transmitter/receivers of all types.

1. A communication system that enables remote land line station devices to make and receive calls over a wireless network using a wireless phone, such as a cell phone, in series between said wireless network and said remote land line station devices, said system comprising:
a plurality of wireless interfaces;
a cell phone base unit coupled to a first one of said wireless interfaces;
said cell phone base unit is adapted to be coupled signal-wise to a cell phone;
at least one remote land line station device coupled to another one of said wireless interfaces; and
apparatus including said wireless interfaces responsive to the receipt of an incoming call from said wireless network for extending said incoming call via said cell phone to said at least one remote land line station device.

2. The system of claim 1 characterized in that said apparatus for extending further comprises:
apparatus that monitors said incoming call; and
apparatus that detects an on-hook signal at said at least one remote land line station device for terminating said call between said remote land line station device and said wireless network via said cell phone and said wireless interfaces.

3. The system of claim 2 characterized in that said apparatus for extending further comprises:
apparatus responsive to the initiation of an outgoing call by said at least one remote land line station device for extending said outgoing call via said wireless interfaces and said cell phone and said wireless network to a called station.

4. The system of said claims 1 characterized in that said at least one remote land line station device comprises any one of or any combination of:
land line phones;
cell phones;
wireless phones;
cordless phones;
computers;
PDAs;
communication paths extending to other networks and/or network appliances;
fax machines;
fire, security and alarm detection devices;
printers; and
household appliances.

5. The system of claim 4 further comprising:
apparatus that detects an off-hook state of a calling one of said remote land line station devices;
apparatus including said wireless interfaces that transmits said off-hook signal from said calling remote land line station device to said cell phone;
apparatus that activates said cell phone in response to the receipt of said on-hook signal;
apparatus including said wireless interface associated with said calling remote land line station device for receiving a called station number from said calling remote land line station device;
apparatus including said wireless interface associated with said calling remote land line station device for transmitting said called station number to said cell phone;
said cell phone being responsive to the receipt of said called station number for initiating the establishment of a call via said wireless network to said called station;
apparatus for detecting an on-hook state of said called station or of said calling remote land line station remote land line station device for transmitting a call end signal to said cell phone; and
said cell phone being responsive to said receipt of said call end signal for ending said call to said called station.

6. The system of claim 4 further comprising:
apparatus including said cell phone for detecting the receipt of an incoming call from said wireless network;
apparatus including said cell phone responsive to said detecting for applying a ringing control signal to the wireless interface associated with said cell phone;
apparatus for transmitting said ringing control signal to the wireless interfaces associated with said remote land line station devices;
apparatus responsive to the receipt of said, ringing control signal for applying ringing current to said remote land line station devices;
apparatus for generating an off-hook signal at a responsive one of remote land line station devices;
said off-hook signal is transmitted to said cell phone via said wireless interfaces;
said cell phone being responsive to the receipt of said off-hook signal for terminating the generation of said ring control signal;
said wireless interfaces being responsive to the termination of said ringing control signal for termination ringing at said remote land line station devices;
said cell phone being effective to monitor said in coming call;
apparatus for detecting an on-hook state of said called station or of said responsive remote land line station device for transmitting a call end signal to said cell phone; and
said cell phone being responsive to said receipt of said call end signal for ending said incoming call.

7. The system of claim 1 characterized in that said cell phone is adapted to serve calls between said wireless network and said remote land line devices only when said cell phone is connected signal-wise to said base unit to connect said cell phone with said first wireless interface via said base unit.

8. In a system having a first wireless interface adapted to be coupled to a cell phone, said system further having a second wireless interface adapted to be coupled to a remote land line station device;
said system further comprising:
apparatus for receiving indicia of a call request in either said first or said second wireless interfaces; and
apparatus extending said call request to the other of said first or second wireless interfaces to extend a call between said cell-phone and said remote land line device via said first and second wireless interfaces.

9. The system of claim 8 characterized in that:
said apparatus for receiving is operable to receive said indicia within said first wireless interface from said cell phone and to extend said call via said second wireless interface to said remote land line station device; and
said apparatus for receiving is also operable to receive said indicia within said second wireless interface from said remote land line station device and to extend said call via said first wireless interface to said cell phone.

10. A method of operating the system of claim 8 comprising the steps of:
receiving indicia of a call request in either said first or said second wireless interfaces; and
extending said call request to the other of said first or second wireless interfaces to extend a call between said cell phone and said remote land line station device via said first and second wireless interfaces.

11. The method of claim 10 wherein:
said step of receiving receives said indicia within said first wireless interface from said cell phone and extends said call via said second wireless interface to said remote land line station device; and
said step of extending receives said indicia within said second wireless interface from said land line station device and extends said call via said first wireless interface to said cell phone.

12. A method of operating a communication system adapted to enable remote land line station devices to make and receive calls over a wireless network using a wireless phone, such as a cell phone, in series between said wireless network and said remote land line station devices, said system comprising:
a plurality of wireless interfaces;
a cell phone base unit coupled to a first one of said wireless interfaces;
said cell phone base unit is adapted to be coupled signal-wise to a cell phone;
at least one remote land line station device coupled to another one of said wireless interfaces; said method comprising the step of:
operating apparatus within said wireless interfaces responsive to the receipt of an incoming call from said wireless network for extending said incoming call via said cell phone and said wireless interfaces to said at least one remote land line station device.

13. The method of claim 12 further comprising the steps of:
monitoring said incoming call; and
operating said cell phone for detecting an on-hook signal generated by said at least one remote land line station device for terminating said call between said remote land line station device and via said wireless network via said cell phone.

14. The method of claim 13 further comprising the step of:
detecting the initiation of an outgoing call by said at least one remote land line station device for extending said outgoing call via said wireless interfaces and said cell phone and via said wireless network to a called station.

15. The method of said claim 12 characterized in that said at least one remote land line station device comprises any one of or any combination of:
land line phones;
cell phones;
wireless phones;
cordless phones;
computers;
printers;
PDAs;
communication paths extending to other networks and/or network appliances;
fax machines;
fire, security and alarm detection devices; and
household appliances.

16. The method of claim 15 further comprising the steps of:
detecting an off-hook state of a calling one of said remote land line station devices;
transmitting said off-hook signal from said calling remote land line station device to said cell phone;
activating said cell phone in response to the receipt of said off-hook signal;
transmitting a called station number from said calling remote land line station device to said wireless interface associated with said calling remote land line station device;
transmitting said called station number from said wireless interface associated with said calling remote land line station device to said cell phone; and
operating said cell phone responsive to the receipt of said called station number for initiation the establishment of a call via said wireless network to said called station.

17. The method of claim 16 further including the steps of:
detecting an on-hook state of said called station or said calling remote land line station device and transmitting a call end signal to said cell phone;
said cell phone being responsive to said receipt of said call end signal for ending said call to said called station.

18. The method of claim 17 characterized in that said system exchanges the following signals between said calling remote land line station device and said cell phone during the serving of a call initiated by said calling remote land line station device:
an off-hook signal generated by said calling remote land line station device is transmitted via said wireless interfaces to said cell phone;
said calling remote land line station device dials the number of the called station to which said call is to be extended;
said dialed number is transmitted to said cell phone which transmits said dialed number to said wireless network for the establishment of a connection to said called station;
said cell phone monitors said call until an on-hook signal is detected at said calling remote land line station device and/or at said called station;
said cell phone is responsive to the detection of said off-hook signal to terminate the call between said calling remote land line station device and said called station.

19. The method of claim 17 characterized in that said system exchanges the following signals between said cell phone and said calling remote land line station devices during the serving of a call received by said cell phone from said wireless network
in response to receipt of a call from said wireless network said cell phone transmits a ringing control signal via said wireless interfaces of said remote land line station devices;
said ringing control signal activates a ring generator in the wireless interface associated with each of said remote land line station devices to apply ringing current to of said remote land line station devices;
the generation of an off-hook signal at a responding one of said remote land line station devices transmits a signal to the wireless interface associated with said cell phone to terminate the generation of said ringing control signal by said cell phone;
said cell phone terminates the generation of said ringing control signal to terminate ringing at said remote land line station devices;
said cell phone establishes a voice path between said cell phone and said responding one of said remote land line station devices.
said cell phone monitors said call and terminates said call upon the generation of an on-hook signal by said responding one of said remote land line station devices.

20. The method of claim 15 characterized in that step of operating said cell phone is effective to serve calls between said wireless network and said remote land line station devices only when said cell phone is connected signal-wise to said base unit to connect said cell phone with said first wireless interface via said base unit.
